(19) United States
(12) Patent Application Publication
(10) Pub. No.: US 2013/0201954 A1
(43) Pub. Date: Aug. 8, 2013

(54) Device to Device and Connection Mode Switching

(71) Applicants: Chunyan Gao, Beijing (CN); Haiming Wang, Beijing (CN); Gilles Charbit, Farnborough (GB)

(72) Inventors: Chunyan Gao, Beijing (CN); Haiming Wang, Beijing (CN); Gilles Charbit, Farnborough (GB)

(73) Assignee: Keilalahdentie 4, Espoo (FI)

(21) Appl. No.: 13/877,531

(22) PCT Filed: Oct. 14, 2010
(86) PCT No.: PCT/CN2010/077729

§ 371 Date: Apr. 3, 2013

(51) Int. Cl. H04W 72/04

(52) U.S. Cl. CPC H04W 72/0413
USPC 370/329

(57) ABSTRACT

The exemplary embodiments of this invention provide, in one aspect thereof, a method that includes sending a mode switch command from a network access node to a first node of a pair of nodes operating in a device-to-device (D2D) communication mode. The method further includes receiving at least one acknowledgment of the reception of the mode switch command at the network access node, where the at least one acknowledgment is received from a second node of the pair of nodes. In one embodiment the mode switch command is an explicit mode switch command sent using layer 1 (L1) signaling to a master node of the pair of nodes. In another embodiment the mode switch command is an implicit mode switch command that includes a downlink grant to schedule the first node in the network, where the downlink grant contains a radio network identifier (RNTI) of the first node of the pair of nodes, and where the acknowledgment of the reception of the mode switch command is received from the second node of the pair of nodes and also from the first node of the pair of nodes. The exemplary embodiments also encompass user devices, such as mobile phones, that operate in the D2D mode in conjunction with the network access node.

### TECHNICAL FIELD

The exemplary and non-limiting embodiments of this invention relate generally to wireless communication systems, methods, devices and computer programs and, more specifically, relate to mobile wireless communication nodes and devices capable of directly communicating with one another, and to their operation with a wireless network access node.

### BACKGROUND

This section is intended to provide a background or context to the invention that is recited in the claims. The description herein may include concepts that could be pursued, but are not necessarily ones that have been previously conceived, implemented or described. Therefore, unless otherwise indicated herein, what is described in this section is not prior art to the description and claims in this application and is not admitted to be prior art by inclusion in this section.

The following abbreviations that may be found in the specification and/or the drawing figures are defined as follows:
3GPP third generation partnership project
ACK acknowledgment
BS base station
CCE control channel element
D2D device-to-device
DCI downlink control information
DL downlink (eNB towards UE)
eNB E-UTRAN Node B (evolved Node B)
EPC evolved packet core
E-UTRAN evolved UTRAN (LTE)
FDD frequency division duplex
FDMA frequency division multiple access
GP guard period
HARQ hybrid autonomous retransmission request
IMTA international mobile telecommunications association
ITU-R international telecommunication union-radiocommunication sector
LTE long term evolution of UTRAN (E-UTRAN)
LTE-A LTE advanced
MAC medium access control (layer 2, L2)
MM/MME mobility management/mobility management entity
NACK negative acknowledgment
NodeB base station
OFDMA orthogonal frequency division multiple access
O&M operations and maintenance
PAPR peak to average power ratio
PDCP packet data convergence protocol
PDCCH physical downlink control channel
PDSCH physical downlink shared channel
PHY physical (layer 1, L1)
PUCCH physical uplink control channel
Rel release
RLC radio link control
RNTI radio network temporary identifier
RRC radio resource control
RRM radio resource management
SGW serving gateway
SC-FDMA single carrier, frequency division multiple access
TDD time division duplex
TPC transmission power control
UE user equipment, such as a mobile station, mobile node or mobile terminal
UL uplink (UE towards eNB)
UPE user plane entity
UTRAN universal terrestrial radio access network

One modern communication system is known as evolved UTRAN (E-UTRAN, also referred to as UTRAN-LTE or as E-UTRA). In this system the DL access technique is OFDMA, and the UL access technique is SC-FDMA.

One specification of interest is 3GPP TS 36.300, V8.11.0 (2009-12), 3rd Generation Partnership Project; Technical Specification Group Radio Access Network; Evolved Universal Terrestrial Radio Access (E-UTRA) and Evolved Universal Terrestrial Access Network (EUTRAN); Overall description; Stage 2 (Release 8), incorporated by reference herein in its entirety. This system may be referred to for convenience as LTE Rel-8. In general, the set of specifications given generally as 3GPP TS 36.xyz (e.g., 36.211, 36.311, 36.312, etc.) may be seen as describing the Release 8 LTE system. More recently, Release 9 versions of at least some of these specifications have been published including 3GPP TS 36.300, V9.3.0 (2010-03).

FIG. 1 reproduces FIG. 4.1 of 3GPP TS 36.300 V8.11.0, and shows the overall architecture of the EUTRAN system (Rel-8). The E-UTRAN system includes eNBs, providing the E-UTRAN user plane (PDCP/RLC/MAC/PHY) and control plane (RRC) protocol terminations towards the UEs. The eNBs are interconnected with each other by means of an X2 interface. The eNBs are also connected by means of an S1 interface to an EPC, more specifically to a MME by means of a S1 MME interface and to a S-GW by means of a S1 interface (MME/S-GW 4). The S1 interface supports a many-to-many relationship between MMEs/S-GWs/UPEs and eNBs.

The eNB hosts the following functions:

functions for RRM: RRC, Radio Admission Control, Connection Mobility Control, Dynamic allocation of resources to UEs in both UL and DL (scheduling);

IP header compression and encryption of the user data stream;

selection of a MME at UE attachment;

routing of User Plane data towards the EPC (MME/S-GW);

scheduling and transmission of paging messages (originated from the MME);

scheduling and transmission of broadcast information (originated from the MME or O&M); and

a measurement and measurement reporting configuration for mobility and scheduling.

Of particular interest herein are the further releases of 3GPP LTE (e.g., LTE Rel-10 and beyond Rel-10) targeted towards future IMTA systems, referred to herein for convenience simply as LTE-Advanced (LTE-A). Reference in this regard may be made to 3GPP TR 36.913, V9.0.0 (2009-12), 3rd Generation Partnership Project; Technical Specification Group Radio Access Network; Requirements for Further Advancements for E-UTRA (LTE-Advanced) (Release 9). Reference can also be made to 3GPP TR 36.912 V9.2.0 (2010-03) Technical Report 3rd Generation Partnership Project; Technical Specification Group Radio Access Network; Feasibility study for Further Advancements for E-UTRA (LTE-Advanced) (Release 9).

A goal of LTE-A is to provide significantly enhanced services by means of higher data rates and lower latency with reduced cost. LTE-A is directed toward extending and optimizing the 3GPP LTE Rel-8 radio access technologies to provide higher data rates at lower cost. LTE-A will be a more optimized radio system fulfilling the ITU-R requirements for IMT-Advanced while keeping the backward compatibility with LTE Rel-8.

Device to Device (D2D) communication is attracting significant interest for at least the following reasons:

it is seen as a potential technique for improve local area coverage;

it is seen as a potential solution to improve resource efficiency;

it can aid in conserving both UE and eNB transmit (Tx) power;

it can aid in reducing the load on the cellular network; and

it has the potential to provide new types of services for end users.

When integrating D2D into, for example, a cellular system there are different approaches that can be used. These approaches can mainly be classified into two categories (autonomous D2D and eNB-controlled in-band D2D). Due to the advantages of high QoS, high resource efficiency and more controllability by network operators, the eNB-controlled in-band D2D approach is currently being pursued with a higher priority than the autonomous D2D for standardization in the near term (e.g., LTE Rel-11, LTE Rel-12). The autonomous D2D is currently seen as a longer-term development.

### SUMMARY

The foregoing and other problems are overcome, and other advantages are realized, by the use of the exemplary embodiments of this invention.

In a first aspect thereof the exemplary embodiments of this invention provide a method that comprises sending a mode switch command from a network access node to a first node of a pair of nodes operating in a device-to-device communication mode. The method further comprises receiving at least one acknowledgment of the reception of the mode switch command at the network access node, where the at least one acknowledgment is received from a second node of the pair of nodes.

In a further aspect thereof the exemplary embodiments of this invention provide an apparatus that comprises at least one processor and at least one memory including computer program code. The memory and computer program code are configured to, with the at least one processor, cause the apparatus to send a mode switch command from a network access node to a first node of a pair of nodes operating in a device-to-device communication mode, and to receive at least one acknowledgment of the reception of the mode switch command at the network access node, where the at least one acknowledgment is received from a second node of the pair of nodes.

In another aspect thereof the exemplary embodiments of this invention provide a method that comprises receiving a mode switch command at a first node of a pair of nodes operating in a device-to-device communication mode, where the mode switch command is received from a second node of the pair of nodes in response to the second node receiving the mode switch command from a network access node of an overlay network. The method further comprises sending an acknowledgment of the reception of the mode switch command from the first node to the network access node.

In yet another aspect thereof the exemplary embodiments of this invention provide an apparatus that comprises at least one processor and at least one memory including computer program code. The memory and computer program code are configured to, with the at least one processor, cause the apparatus to receive a mode switch command at a first node of a pair of nodes operating in a device-to-device communication mode, where the mode switch command is received from a second node of the pair of nodes in response to the second node receiving the mode switch command from a network access node of an overlay network; and to send an acknowledgment of the reception of the mode switch command from the first node to the network access node.

### BRIEF DESCRIPTION OF THE DRAWINGS

In the attached Drawing Figures:

FIG. 1 reproduces FIG. 4.1 of 3GPP TS 36.300, and shows the overall architecture of the EUTRA.N system.

FIG. 2 shows a simplified block diagram of various electronic devices that are suitable for use in practicing the exemplary embodiments of this invention.

FIG. 3 presents an example of a frequency division multiplexed cellular connectivity resource and D2D resource.

FIG. 4 presents an example of a time division multiplexed cellular connectivity resource and D2D resource.

FIG. 5 shows an example of a mode switch delay.

FIG. 6 presents an example of device connectivity to a cellular network when operating in the D2D communication mode.

FIG. 7 is a logic flow diagram that illustrates the operation of a method, and a result of execution at a network access node of computer program instructions embodied on a computer readable memory, in accordance with the exemplary embodiments of this invention.

FIG. 8 is a logic flow diagram that illustrates the operation of a method, and a result of execution at a D2D device of computer program instructions embodied on a computer readable memory, in accordance with the exemplary embodiments of this invention.

### DETAILED DESCRIPTION

The eNB-controlled in-band D2D communication that was discussed above can be implemented in both FDD and TDD cellular systems. When D2D nodes are operating in cellular UL resources (FDD UL band or TDD UL subframes) the eNB is enabled to measure the interference from the D2D communication, and the D2D nodes can receive control/data from the eNB in DL cellular resources. However, D2D nodes operating in DL resources should also be considered, especially when implemented in a TDD cellular system. This is true because in some cases, where a DL-heavy TDD configuration is adopted in the cellular system, there are only a relatively few UL resources available for use by the D2D nodes.

For D2D communication underlying a TDD cellular network there are various possible scenarios for D2D resource configuration that can be considered, such as:
scenario1: D2D nodes communicate only in UL sub-frames of the cellular network;
scenario2: D2D nodes communicate during the guard period (GP) of a special subframe, and in UL subframes of the cellular network; and
scenario3: D2D nodes communicate in part of the DL subframe, the GP of the special subframe, and UL subframes of the cellular network.

For each of these D2D resource allocation scenarios, device connectivity to the cellular network when in the D2D mode should be enabled at least for the purposes of (by example) accessing cellular system information, synchronization, obtaining DL control/traffic from the eNB or for the purpose of UL traffic.

The exemplary embodiments of this invention pertain at least in part to principles and signaling design to enable D2D connectivity to the cellular system at least for the purpose of DL traffic.

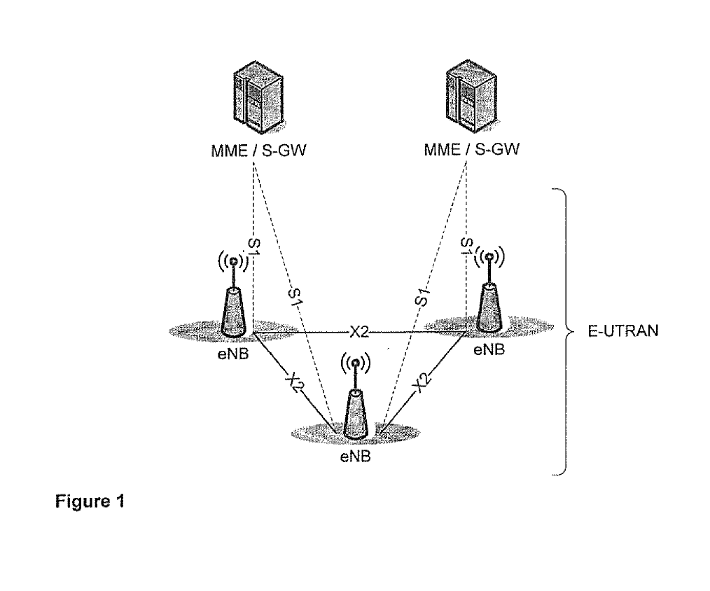

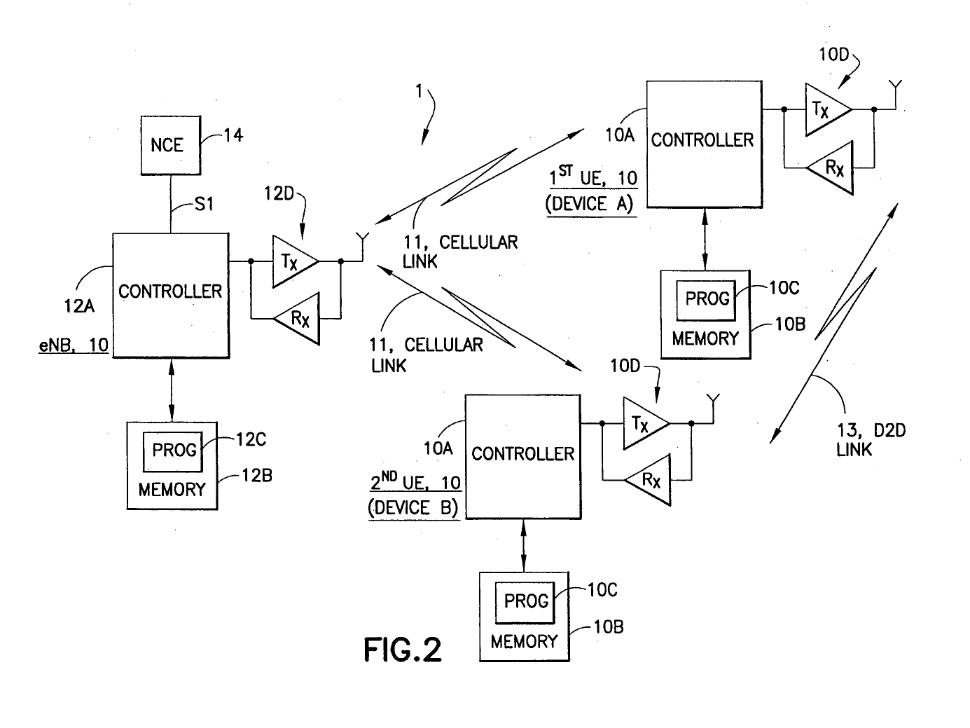

Before describing in further detail the exemplary embodiments of this invention, reference is made to FIG. 2 for illustrating a simplified block diagram of various electronic devices and apparatus that are suitable for use in practicing the exemplary embodiments of this invention. In FIG. 2 a wireless network 1, which may be a cellular wireless network, is adapted for communication over a wireless, e.g., cellular link 11 with an apparatus, such as a mobile communication device which may be referred to as a first UE 10, via a network access node, such as a Node 13 (base station), and more specifically an eNB 12. The cellular network 1 may include a network control element (NCE) 14 that may include the MME/SGW functionality shown in FIG. 1, and which can provide connectivity with a further network, such as a telephone network and/or a data communications network (e.g., the Internet). The UE 10 includes a controller 10A, such as at least one computer or a data processor, at least one non-transitory computer-readable memory medium embodied as a memory 10B that stores a program of computer instructions (PROG) 10C, and at least one suitable radio frequency (RF) transmitter and receiver pair (transceiver) 10D for bidirectional wireless communications with the eNB 12 via one or more antennas. The eNB 12 also includes a controller 12A, such as at least one computer or a data processor, at least one computer-readable memory medium embodied as a memory 12B that stores a program of computer instructions (PROG) 12C, and at least one suitable RF transceiver 12D for communication with the UE 10 via one or more antennas (typically several when multiple input/multiple output (MIMO) operation is in use). The eNB 12 can be coupled via a data/control path to the NCE 14, where the path may be implemented as the S1 interface shown in FIG. 1. The eNB 12 may also be coupled to another eNB via the X2 interface shown in FIG. 1.

FIG. 2 shows the presence of a second UE 10 which may or may not be identically constructed as the first UE 10 (e.g., they may or may not be made by the same manufacturer). The transceivers 10D of the first and second UEs 10 are capable of wireless, direct communication via a D2D link 13. The first and second UEs 10 may thus be considered for the purposes of this description as being “D2D nodes” or “D2D terminals”, without a loss of generality, and for simplicity one may be referred to below as ‘device A’ and the other referred to as ‘device B’. When in the D2D connection mode one of the D2D nodes can be considered to be a master D2D node, and the other a slave D2D node. Also, when operating in the D2D mode communication with the cellular system 1 via the eNB 12 can be accomplished, as will be described in detail below.

It can be noted that is some use cases and deployments at least one of the D2D nodes can be a fixed (non-mobile) device/node. For example, one of the D2D nodes could function as a media content server capable of D2D communication with a population of mobile D2D nodes (UEs 10) in the vicinity of the fixed D2D node.

The programs 10C and 12C are assumed to include program instructions that, when executed by the associated controller 10A, 12A, enable the device to operate in accordance with the exemplary embodiments of this invention, as will be discussed below in greater detail. That is, the exemplary embodiments of this invention may be implemented at least in part by computer software executable by the controller 10A of the UE 10 and/or by the controller 12A of the eNB 12, or by hardware, or by a combination of software and hardware (and firmware).

In general, the various embodiments of the UEs 10 can include, but are not limited to, cellular telephones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The computer-readable memories 10B and 12B may be of any type suitable to the local technical environment and may be implemented using any suitable data storage technology, such as semiconductor based memory devices, random access memory, read only memory, programmable read only memory, flash memory, magnetic memory devices and systems, optical memory devices and systems, fixed memory and removable memory. The controllers 10A and 12A may be of any type suitable to the local technical environment, and may include one or more of general purpose computers, special purpose computers, microprocessors, digital signal processors (DSPs) and processors based on multi-core processor architectures, as non-limiting examples.

For the ensuing discussion reference can be made to, for example, 3GPP TS 36.211 V9.1.0 (2010-03) Technical Specification 3rd Generation Partnership Project; Technical Specification Group Radio Access Network; Evolved Universal Terrestrial Radio Access (E-UTRA); Physical Channels and Modulation (Release 9), for a description of the PUCCH (section 5.4), the PDSCH (section 6.4), and the PDCCH and CCEs (section 6.8). Reference can also be made to, for example, 3GPP TS 36.212 V9.2.0 (2010-06) Technical Specification 3rd Generation Partnership Project; Technical Specification Group Radio Access Network; Evolved Universal Terrestrial Radio Access (E-UTRA); Multiplexing and channel coding (Release 9), for a description of various DCI formats, including DCI format 3 (section 5.3.3.1).

It is pointed out and should be kept in mind that while the exemplary embodiments of this invention are described herein in the context of cellular-type radio communication networks, such as an LTE-A network, the exemplary embodiments can be used as well in non-cellular types of networks including, for example, in a wireless local area network (WLAN). Thus, references herein to network access nodes and base stations can be considered to refer to cellular-type network access nodes and base stations, such as the eNB 12, but can also be considered to refer to non-cellular types of network access nodes and base stations. Further, any references herein to specific cellular-types of standards documents that are descriptive of certain UL and DL channels and information elements should not be considered as limiting the application of the exemplary embodiments to only cellular-types of wireless communication systems and networks. The same applies to the user devices that participate in the D2D communication, i.e., they can be configured to operate as a cellular-type of user device, or as a non-cellular type of user device or, in some embodiments, the user device may be capable of both cellular and non-cellular types of wireless communications.

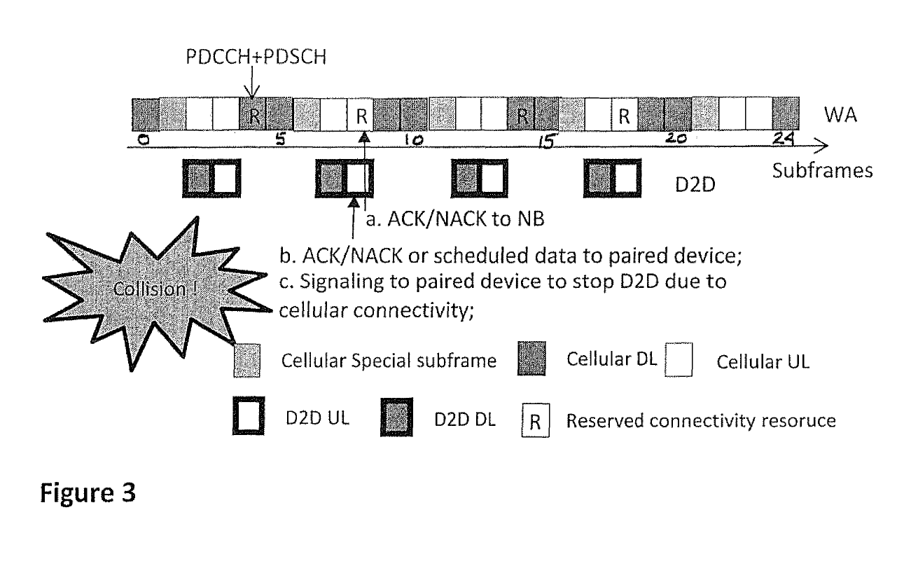

As was discussed above, device (UE 10) connectivity to the eNB 12 via the cellular connection (link) 11 is preferably enabled even when the device is connected via link 13 to a paired device in the D2D mode, as shown in FIG. 2. In order to support the eNB 12 connectivity, in one approach one can reserve some dedicated DL and UL resources for the DL and UL connectivity to the eNB 12. These ‘reserved’ resources for cellular connectivity should not, by definition, be used for D2D communication. If the reserved resources for cellular connectivity are frequency division multiplexed with D2D resources, then it may cause the problem of simultaneous transmission from one device (e.g., the 1st UE 10 or device A) to both the eNB 12 and the paired device (the 2nd UE 10 or device B), as shown in FIG. 3.

In the example of FIG. 3 one can assume that D2D operates in the wide area (WA) cellular UL resources, and that both the D2D communication and cellular communication use the TDD mode. The D2D node monitors the DL subframes from the eNB 12 in a reserved DL connectivity subframe and can transmit to the eNB 12 in the reserved UL connectivity subframe. If a device A detects a DL grant and PDSCH for it in subframe 4, then it needs to feedback ACK/NACK information to the eNB 12 in subframe 8 (note in FIG. 3 and the other similar Figures that the subframe numbering begins with subframe “zero”, i.e., subframe index 0). However, since the paired device B is not aware of the ongoing cellular DL traffic for device A, then the paired device B will assume the D2D mode and expect control/data from device A in subframe 8. This implies that device A should send two different transmissions with different content in subframe 8:

a. ACK/NACK signaling that is sent to the eNB 12 in the cellular connection mode corresponding to the received PDSCH in subframe 4; and

b. ACK/NACK or scheduled data to device B in the D2D connection mode corresponding to a previous data transmission or scheduling grant.

Such simultaneous transmissions to both the eNB and the paired D2D node can be difficult to achieve in a practical UE 10 implementation. For example, the cellular UL power control will require that the UE 10 transmission (device A) satisfy the maximum Tx power limitation, the transmission Tx limitation for the D2D mode, and the Tx power for cellular transmission. Second, such a simultaneous transmission also increases the UL transmission peak to average power ratio (PAPR), and may require a larger power backoff to avoid exceeding a maximum power amplifier (PA) power limitation. However, the use of a larger power backoff will result in smaller UL coverage and degrade the detection performance. Another problem relates to the potential large in-band interference resulting from simultaneous transmission: the ACK/NACK transmission to the eNB 12 via the cellular connection is made with relatively high power, which may cause inband interference to devices depending on the frequency separation, and the relative device-to-eNB and device-to-paired device distances. It can thus be appreciated that simultaneous transmissions from the D2D node (device A) to both the device B and to the eNB 12 should be avoided if possible.

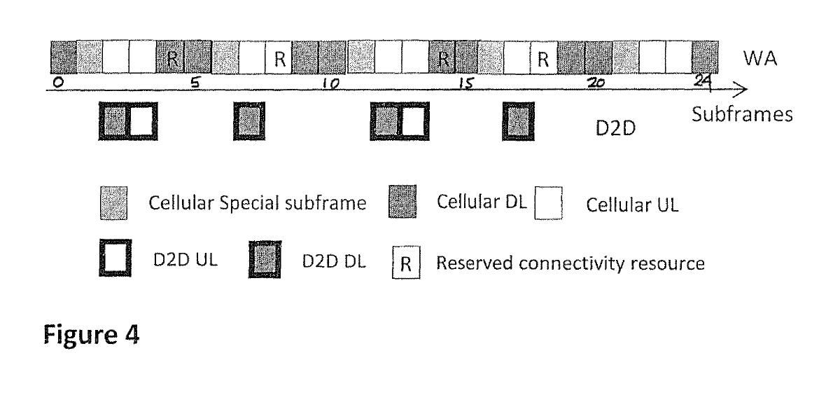

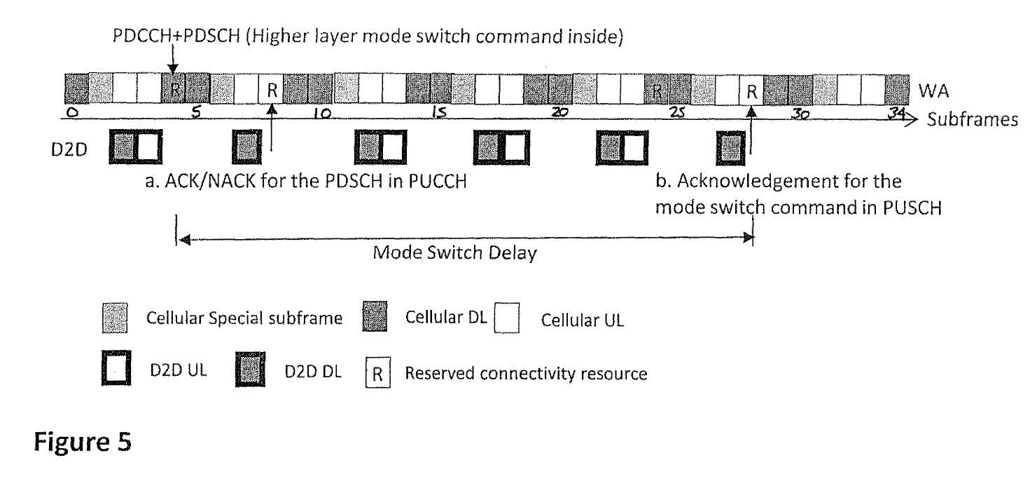

One straightforward way to avoid such a simultaneous transmission is to arrange for the cellular connectivity resource to be time division multiplexed (TDMed) with the D2D resource (FIG. 4 shows one example). For the subframe where there is a resource reserved for cellular connectivity, no D2D communication is allowed. However, the use of this approach can reduce the time resources for D2D communication, and thus may cause a severe performance problem for the D2D node operating in TDD cellular. This is true at least for the reason that when considering the avoidance of large interference from the cellular eNB 12, it would be preferred for the D2D communication mode to only re-use cellular UL resources. However, among all seven defined TDD configurations in the 3GPF Rel-8 specifications, there are at the most six UL subframes available per 10 ms frame (e.g., for TDD configuration0). Thus, if it is necessary to reserve some subframes for cellular connectivity, the resources available for D2D communication will be further reduced. In addition, the limited resources should be further divided into Tx and Rx parts, which will result in a substantial HARQ delay. In such cases the eNB 12 would need to carefully balance the available UL subframes for D2D and cellular connections. It is a reasonable assumption that when some UE 10 is configured to be in the D2D mode that there would be little cellular traffic for the UE 10 and, also in most cases, the D2D node only needs to monitor some infrequent D2D configuration signaling from the eNB 12. Moreover, as the D2D configuration will likely not be dynamic, the cellular connectivity resource for the D2D node may not be reserved per 10 ms frame, instead, it can be reserved with a relatively longer period, e.g., 20 ms, 50 ms, or even longer. However, with such a reservation of the cellular connectivity resource a problem can arise in that the response delay of the D2D node to eNB 12 higher layer signaling can be excessive, as shown in the mode switch delay example of FIG. 5.

The ‘mode switch’ is considered herein as being, for example, executed in (or initiated in) response to a command received from the eNB 12, where a node (UE 10) that is operating in the D2D communication mode leaves the D2D mode and operates, at least temporarily, only in the cellular mode. This can occur, for example, when the eNB 12 determines that it has data to send from the cellular system to the UE 10.

In addition to the increased delay problem shown in FIG. 5, there is another problem in the mode switch due to the emerging cellular DL traffic. The cellular DL traffic is triggered by the eNB 12, thus the D2D node is not aware of the mode switch before correctly detecting the signaling for the mode switch. As such, a mechanism/procedure is needed to ensure that both D2D nodes (device A, device B) correctly are aware of the need for the mode switch and to thus avoid the presence of mode status ambiguity in the device pair.

The exemplary embodiments of this invention provide principles and signaling mechanisms for device connectivity to the network via the cellular connection mode, and to a paired device via the D2D connection mode, to avoid the above problems, such as by removing the mode status ambiguity in the device pair.

Several possible solutions to avoid the identified problems are described below, each representing an exemplary embodiment of this invention and each including principles for the mode switch procedure and signaling design. Each embodiment assumes that there are reserved DL subframes for the UE 10 to connect to the eNB 12 via the cellular connection mode while the UE 10 is in the active D2D connection mode, and reserved UL subframes for the UE 10 to send feedback to the eNB 12. The embodiments described below are applicable to all of the various D2D resource allocation scenarios discussed above.

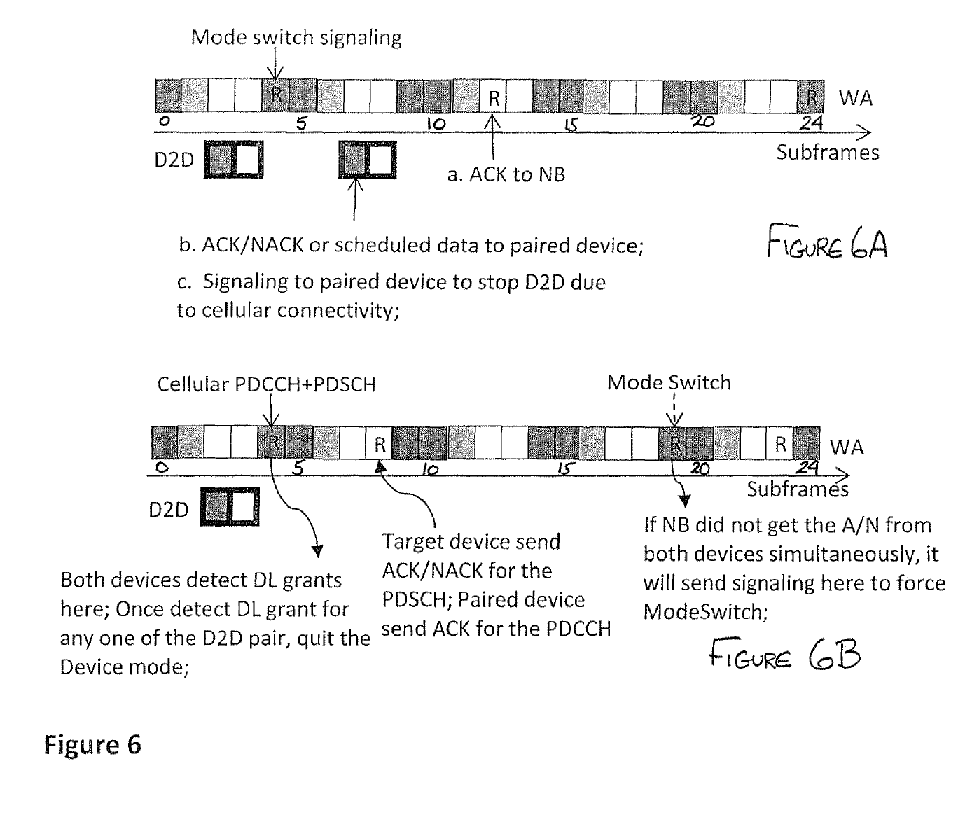

### Solution A (First Exemplary Embodiment of This Invention Shown in FIG. 6A, Explicit Mode Switch Command)

Once configured to be in the D2D connection mode the UE 10 monitors the cellular transmission in some predefined DL subframes with a period of T. The value of T is configured by the eNB 12 and can be different for the cellular connection mode and the D2D connection mode. For example, if T=1 ms then the UE 10 monitors all DL subframes.

For devices in the D2D connection mode, the eNB 12 sends an explicit connection mode switch command via L1 signaling. This explicit connection mode switch command does not have a following PDSCH and does not require the UE 10 to feedback an ACK/NACK with HARQ timing as in the cellular connection mode.

Only the master D2D node in the D2D node pair is required to detect the connection mode switch signaling from the eNB 12. The master D2D node can then inform the slave D2D node of the pair (i.e., the paired UE 10) to terminate the D2D connection mode. Then, t ms later, the slave D2D node sends an ACK to the eNB 12 to indicate that it has exited the D2D mode and switched back to the cellular mode. More generally, the receipt of the ACK by the eNB 12 from the slave D2D node indicates at least that both the master D2D node and the slave D2D node have correctly received the mode switch command and may, or may not, have already switched to the cellular (overlay) network mode of operation. For example, the D2D devices may not necessarily terminate the D2D mode instantly after the ACK is sent, since there is the possibility that the ACK is not detected by the eNB 12. In this case the eNB 12 may send the mode switch command again, e.g., to the master D2D node. Also, in some cases the two D2D nodes may still need to receive some control information from the eNB 12 before leaving the D2D mode and entering the cellular (overlay) network mode of operation. Thus, the reception of the ACK from the slave D2D node at the eNB 12 at least signals the eNB 12 that both D2D nodes have received and correctly interpreted the mode switch command, where the master D2D node receives the mode switch command directly from the eNB 12, and where the slave D2D node receives the mode switch command via the master D2D node.

The ACK to the eNB 12 is sent from the slave D2D node in a predefined UL resource, or in an UL resource indicated in the mode switch command in the reserved subframe for cellular connectivity.

As was described, the L1 explicit connection mode switch signaling is detected by the master D2D node, while the ACK is sent to the eNB 12 by the slave D2D node after it is informed by the master D2D node of the mode switch commanded by the eNB 12. In this manner, when the eNB 12 receives the ACK from the D2D slave node it is informed that both D2D nodes of the D2D pair are at least aware of and may have executed, the connection mode switch.

The connection mode switch signaling is sent as a PDCCH command, e.g., in DCI format 3 for multiple devices. This enables a faster mode switch to be executed as compared to the use of higher layer signaling.

### Solution B (Second Exemplary Embodiment of This Invention Shown in FIG. 6B, Implicit Mode Switch Command)

When there is cellular DL traffic to schedule to one D2D node of the pair the eNB 12 sends a DL grant on the PDCCH and PDSCH directly to the D2D node. The DL grant functions in this case as an implicit connection mode switch command. In this embodiment each D2D node of the D2D connection pair monitors the DL grants for both D2D nodes. If detection of a DL grant for either D2D node occurs the paired D2D nodes automatically terminate the D2D connection mode and switch to the cellular connection mode. In this case the D2D node that is actually scheduled by the DL grant on the PDSCH sends an ACK/NACK to the eNB 12 for the PDSCH, while the other paired D2D node sends an ACK to the eNB 12 to indicate its detection of the DL grant for the other D2D node. If the eNB 12 does not receive an ACK/NACK from each node of the D2D node pair it sends explicit mode switch signaling, as per the first embodiment (solution A) in order to force the mode switch to occur.

Several examples are now provided to illustrate the operation of the first and second exemplary embodiments. While the embodiments apply to any D2D resource allocation scenario, in these examples the first resource allocation scenario is assumed, i.e., where only the UL resource is used for D2D.

In FIG. 6A, which pertains to solution A, when there is DL traffic for one (or both) of the nodes in the D2D node pair, the eNB 12 sends signaling to explicitly inform the D2D nodes of the connection mode switch. The signaling can reuse the DCI format in the cellular network, e.g., DCI format 3, whereby the eNB 12 can indicate the mode switch for multiple devices. Note that in the cellular mode the eNB 12 can send transmission power control (TPC) commands to multiple UEs 10 using the DCI format 3. This type of signaling does not require the receiving UE 10 to feedback to the eNB 12 according to cellular HARQ timing. The eNB 12 can thus preconfigure one time delay, such as by having the D2D node acknowledge the reception of the DL DCI format 3 signaling t ms later in a predefined resource after both nodes of the D2D node pair terminate the D2D connection mode. To ensure that both D2D nodes are aware of the connection mode switch, the eNB 12 configures the master D2D node to monitor the DL signaling. The master D2D node then informs the slave D2D node, by D2D signaling, of the receipt of the explicit mode switch command. The slave D2D node in turn then sends an acknowledgment to the cellular eNB 12. Following detection of the acknowledgment from the slave D2D node the eNB 12 knows that both D2D nodes have terminated the D2D connection mode. If the eNB 12 does not receive the acknowledgment in the predefined time t the eNB 12 can repeat the process, and continue doing so until it receives the acknowledgment of the connection mode switch signaling from the slave D2D node.

FIG. 6B presents an example for solution B, where the eNB 12 sends the DL grant and PDS CH directly to the target UE 10 when there is DL traffic for the UE 10. In predefined DL subframes each D2D node is enabled to detect the PDCCH for itself as well as the paired D2D node. This embodiment thus assumes that each UE 10 has knowledge of the radio network temporary identifier (RNTI) of the UE 10 with which it is paired in the D2D communication mode. When there is a received indication of DL scheduling for any one of the paired D2D nodes then both paired D2D nodes automatically terminate the D2D mode. To ensure that the paired D2D nodes have correctly detected the DL grant both nodes send ACK/NACK to the eNB 12. When the eNB 12 detects the acknowledgment from both of the paired D2D nodes it knows that both have terminated the D2D connection mode, otherwise the eNB 12 sends additional signaling as in solution A to explicitly indicate the mode switch command.

The foregoing RNTI may be considered to be in this context the cellular network or cellular RNTI that is associated with the UE 10 when operating in the cellular network. More generically, this RNTI may be referred to as an overlay radio network identifier in order to distinguish it from various D2D-specific radio network identifiers that are discussed below.

In this second exemplary embodiment the UE 10 that is scheduled on the PDSCH sends the ACK/NACK in the PUCCH resource implicitly determined by the first control channel element (CCE) of the PDCCH, according to the PUCCH; while the paired device sends the ACK in the PUCCH corresponding to the second CCE of the PDCCH, or in a PUCCH resource determined by the PUCCH resource of the other UE 10, plus an offset.

Note that, in addition to the DL grant for itself and for the paired D2D node, the master D2D node also monitors the PDCCH and PDSCH for the D2D pair, whose cyclic redundancy check (CRC) may be scrambled with the D2D pair specific RNTI, e.g., the D2D_RNTI. This can be used by the eNB 12 to send configuration signaling for D2D communication mode operation, e.g., for power control and for resource allocation. The reception of such a PDCCH and PDSCH with the CRC scrambled by D2D_RNTI does not trigger the mode switch. Instead, only the reception of the PDCCH and cellular PDSCH whose CRC is scrambled with one of the private RNTIs (e.g., the cell RNTI (C-RNTI) or semi-persistent scheduling RNTI (SPS-RNTI)) of one of the D2D nodes will trigger the mode switch.

It is within the scope of the exemplary embodiments of this invention for the eNB 12 to assign one additional D2D RNTI for each of the D2D nodes in the pair, e.g., a master_RNTI for the master D2D node and a slave_RNTI for the slave D2D node. Using the PDCCH and the PDSCH with the CRC scrambled with the master_RNTI the eNB 12 can send D2D configuration signaling, and the cellular DL data for the master D2D node, and using the PDCCH and the PDSCH with the CRC scrambled with the slave_RNTI the eNB 12 can send cellular DL data for the slave D2D node. These additional master/slave RNTIs enable cellular mode transmission to the UEs 10 that are participating in the D2D pair, without them having to leave the D2D mode, and can be beneficially used in the case where there is a relatively small amount of cellular traffic to send on the DL. The use of this embodiment can thus reduce the frequency of the occurrence of the mode switch operation. Only when the D2D nodes detect PDCCH or/and PDSCH with a CRC scrambled with one of the nodes' cellular RNTI (e.g., C-RNTI, SPS-RNTI) will they leave the D2D communication mode and send the acknowledgment to eNB 12. When the D2D nodes detect PDCCH or/and PDSCH with a CRC scrambled with one of the other ‘special’ RNTIs, e.g., the D2D_RNTI associated with the pair, or the master_RNTI or the slave_RNTI, the D2D nodes of the pair do not execute the mode switch.

It should be appreciated that the use of the exemplary embodiments provides a number of valuable technical effects. For example, one technical effect that arises from the use of the exemplary embodiments for device connectivity to cellular when in the D2D mode is that the common understanding of the mode status between NB and D2D pair is guaranteed, thereby avoiding improper operation due to the presence of mode ambiguity. Another technical effect that is achieved is that the problems related to the simultaneous transmission from the UE 10 of the D2D node pair to both the eNB 12 and to the other node of the D2D node pair is avoided. Another technical effect that is achieved is that the mode switch signaling can be adapted dynamically with the cellular DL traffic, since the signaling is sent in the PDCCH, and reuse of the cellular DCI format (format 3) is made possible. Another technical effect that is achieved is that by using L1 signaling, fast mode switching can be achieved, and thus the latency of mode switching can be reduced. A further technical effect that is achieved is that by using different RNTIs for scrambling the CRC of the PDCCH and the PDSCH, the eNB 12 can selectively control the devices to quit the D2D mode or to stay in the D2D mode, depending on the volume of DL cellular traffic that needs to be delivered.

Based on the foregoing it should be apparent that the exemplary embodiments of this invention provide a method, apparatus and computer program(s) to enhance D2D communication mode operation when the D2D communication underlies a wireless communication network, such as a cellular network such as, but not limited to, an LTE-Advanced cellular network.

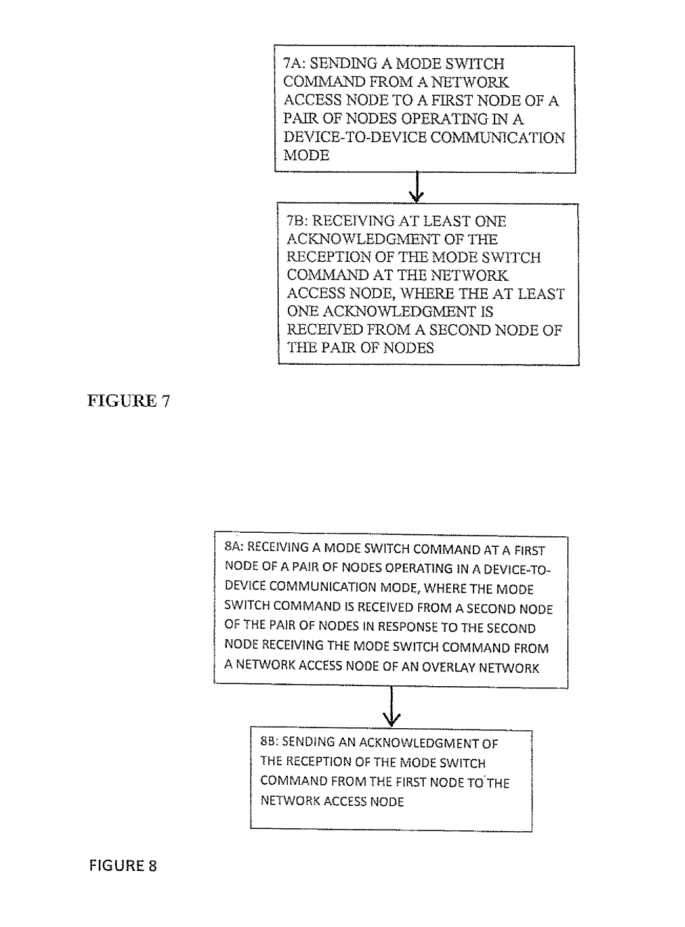

FIG. 7 is a logic flow diagram that illustrates the operation of a method, and a result of execution of computer program instructions, in accordance with the exemplary embodiments of this invention. In accordance with these exemplary embodiments a method performs, at Block 7A, a step of sending a mode switch command from a network access node to a first node of a pair of nodes operating in a device-to-device communication mode. At Block 7B there is a step of receiving at least one acknowledgment of the reception of the mode switch command at the network access node, where the at least one acknowledgment is received from a second node of the pair of nodes.

In the method shown in FIG. 7, the mode switch command is an explicit mode switch command sent using layer 1 signaling to a master node of the pair of nodes.

In the method shown in FIG. 7, the mode switch command is an explicit mode switch command sent using a physical downlink control channel with downlink control information format 3 signaling.

In the method shown in FIG. 7 and described in the preceding paragraphs, where the acknowledgment is received on an uplink resource that is one of predefined or specified in the mode switch command.

In the method shown in FIG. 7 and described in the preceding paragraphs, the acknowledgment of the reception of the mode switch command is interpreted by the network access node that both the first node and the second node have correctly received the mode switch command.

In the method shown in FIG. 7, the mode switch command is an implicit mode switch command that comprises a downlink grant to schedule the first node in the network, where the downlink grant comprises a radio network identifier of the first node of the pair of nodes, and where the acknowledgment of the reception of the mode switch command is received from the second node of the pair of nodes and also from the first node of the pair of nodes.

In the method shown in FIG. 7 and described in the preceding paragraph, where the downlink grant is sent using a physical downlink control channel, and where the first node that is scheduled sends the acknowledgment in a physical uplink control channel resource determined from a first control channel element of the physical downlink control channel, and where the second node sends the acknowledgment in a physical uplink control channel resource determined from one of a second control channel element of the physical downlink control channel or in a physical uplink control channel resource determined by the physical uplink control channel resource used by the first node, plus an offset.

In the method shown in FIG. 7, further comprising in response to not receiving the acknowledgment from the first node and the second node, sending an explicit mode switch command using layer 1 signaling to a master node of the pair of nodes using a physical downlink control channel with downlink control information format 3 signaling.

In the method shown in FIG. 7 and described in the preceding paragraphs, further comprising sending device-to-device communication mode configuration information to the pair of nodes, while they are operating in the device-to-device communication mode, using a physical downlink control channel and a physical downlink shared channel having a cyclic redundancy code that is scrambled using a radio network identifier that is specific to the pair of nodes operating in the device-to-device communication mode.

In the method shown in FIG. 7 and described in the preceding paragraphs, further comprising sending device-to-device communication mode configuration information or downlink data to a master node of the pair of nodes, while the master node is operating in the device-to-device communication mode, using a physical downlink control channel and a physical downlink shared channel having a cyclic redundancy code that is scrambled using a radio network identifier that is assigned to the master node of the pair of nodes operating in the device-to-device communication mode, and that is different from an overlay radio network identifier of the node, and sending downlink data to a slave node of the pair of nodes, while the slave node is operating in the device-to-device communication mode, using a physical downlink control channel and a physical downlink shared channel having a cyclic redundancy code that is scrambled using a radio network identifier that is specific to the slave node of the pair of nodes operating in the device-to-device communication mode, and that is different from an overlay radio network identifier of the node.

The exemplary embodiments also encompass a non-transitory computer-readable medium that contains software program instructions, where execution of the software program instructions by at least one data processor results in performance of operations that comprise execution of the method of FIG. 7 as described in the preceding several paragraphs.

The various blocks shown in FIG. 7 may be viewed as method steps, and/or as operations that result from operation of computer program code, and/or as a plurality of coupled logic circuit elements constructed to carry out the associated function(s).

The exemplary embodiments also pertain to an apparatus that comprises at least one processor and at least one memory that includes computer program code. The memory and computer program code are configured to, with the at least one processor, cause the apparatus to send a mode switch command from a network access node to a first node of a pair of nodes operating in a device-to-device communication mode and to receive at least one acknowledgment of the reception of the mode switch command at the network access node, where the at least one acknowledgment is received from a second node of the pair of nodes.

FIG. 8 is a logic flow diagram that illustrates the operation of a method, and a result of execution of computer program instructions, in accordance with the exemplary embodiments of this invention. In accordance with these exemplary embodiments a method performs, at Block 8A, a step of receiving a mode switch command at a first node of a pair of nodes operating in a device-to-device communication mode, where the mode switch command is received from a second node of the pair of nodes in response to the second node receiving the mode switch command from a network access node of an overlay network. At Block 8B there is a step of sending an acknowledgment of the reception of the mode switch command from the first node to the network access node.

In the method of FIG. 8, the mode switch command is an explicit mode switch command that was sent to the second node using layer 1 signaling, and where the first node is a slave node and the second node is a master node of the pair of nodes.

In the method of FIG. 8, the mode switch command is an explicit mode switch command that was sent to the second node using a physical downlink control channel with downlink control information format 3 signaling, and where the first node is a slave node and the second node is a master node of the pair of nodes.

In the method of FIG. 8 and the preceding paragraphs, where the acknowledgment is transmitted on an uplink resource that is one of predefined or specified in the mode switch command, and indicates to the network access node that both the first node and the second node have correctly received the mode switch command.

In the method of FIG. 8, where the mode switch command is an implicit mode switch command that comprises a downlink grant to schedule the second node in the overlay network, where the downlink grant comprises an overlay radio network identifier of the second node of the pair of nodes, and where the acknowledgment of the reception of the mode switch command is transmitted also from the second node of the pair of nodes.

In the method of FIG. 8 and the preceding paragraph, where the downlink grant is sent using a physical downlink control channel, and where the second node that is scheduled sends the acknowledgment in a physical uplink control channel resource determined from a first control channel element of the physical downlink control channel, and where the first node sends the acknowledgment in a physical uplink control channel resource determined from one of a second control channel element of the physical downlink control channel or in a physical uplink control channel resource determined by the physical uplink control channel resource used by the second node, plus an offset.

In the method of FIG. 8 and the preceding paragraphs, and further comprising a step of receiving device-to-device communication mode configuration information, while operating in the device-to-device communication mode, using a physical downlink control channel and a physical downlink shared channel having a cyclic redundancy code that is scrambled using a radio network identifier that is specific to the pair of nodes operating in the device-to-device communication mode.

In the method of FIG. 8 and the preceding paragraphs, and further comprising a step of receiving at least downlink data, while the first node is operating in the device-to-device communication mode as a slave node, using a physical downlink control channel and a physical downlink shared channel having a cyclic redundancy code that is scrambled using a radio network identifier that is specific to the slave node operating in the device-to-device communication mode, and that is different from an overlay radio network identifier of the slave node.

The exemplary embodiments of this invention also encompass a non-transitory computer-readable medium that contains software program instructions, where execution of the software program instructions by at least one data processor results in performance of operations that comprise execution of the method of FIG. 8 and the preceding several paragraphs descriptive of the method of FIG. 8.

The various blocks shown in FIG. 8 may also be viewed as method steps, and/or as operations that result from operation of computer program code, and/or as a plurality of coupled logic circuit elements constructed to carry out the associated function(s).

The exemplary embodiments also pertain to an apparatus that comprises at least one processor and at least one memory that includes computer program code. The memory and computer program code are configured to, with the at least one processor, cause the apparatus to receive a mode switch command at a first node of a pair of nodes operating in a device-to-device communication mode, where the mode switch command is received from a second node of the pair of nodes in response to the second node receiving the mode switch command from a network access node of an overlay network. The apparatus is further configured to send an acknowledgment of the reception of the mode switch command from the first node to the network access node.

Also disclosed herein is an apparatus that comprises means for sending a mode switch command from a network access node to a first node of a pair of nodes operating in a device-to-device communication mode, and means for receiving at least one acknowledgment of the reception of the mode switch command at the network access node, where the at least one acknowledgment is received from a second node of the pair of nodes.

Also disclosed herein is an apparatus that comprises means for receiving a mode switch command at a first node of a pair of nodes operating in a device-to-device communication mode, where the mode switch command is received from a second node of the pair of nodes in response to the second node receiving the mode switch command from a network access node of an overlay network, and means for sending an acknowledgment of the reception of the mode switch command from the first node to the network access node.

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the exemplary embodiments of this invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

It should thus be appreciated that at least some aspects of the exemplary embodiments of the inventions may be practiced in various components such as integrated circuit chips and modules, and that the exemplary embodiments of this invention may be realized in an apparatus that is embodied as an integrated circuit. The integrated circuit, or circuits, may comprise circuitry (as well as possibly firmware) for embodying at least one or more of a data processor or data processors, a digital signal processor or processors, baseband circuitry and radio frequency circuitry that are configurable so as to operate in accordance with the exemplary embodiments of this invention.

Various modifications and adaptations to the foregoing exemplary embodiments of this invention may become apparent to those skilled in the relevant arts in view of the foregoing description, when read in conjunction with the accompanying drawings. However, any and all modifications will still fall within the scope of the non-limiting and exemplary embodiments of this invention.

For example, while the exemplary embodiments have been described above in the context of the UTRAN LTE-A system, it should be appreciated that the exemplary embodiments of this invention are not limited for use with only this one particular type of wireless communication system, and that they may be used to advantage in other wireless communication systems. For example, and as was noted above, the exemplary embodiments of this invention are not limited for use with only cellular-type radio communication networks, but may be used as well as in non-cellular types of networks including, for example, wireless local area network (WLAN) deployments.

Also by example, while described above generally in the context of two devices participating in the D2D communication, in some cases there can be more than two devices, e.g., there can be one master device and two or more slave devices that form a D2D group or cluster.

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

Further, the various names used for the described parameters (e.g., RNTI, D2D_RNTI, master_RNTI, slave_RNTI, etc.), information elements and channels (e.g., PDCCH, PDSCH, PUCCH, etc.) are not intended to be limiting in any respect, as these parameters, information elements and channels may be identified by any suitable names.

Furthermore, some of the features of the various non-limiting and exemplary embodiments of this invention may be used to advantage without the corresponding use of other features. As such, the foregoing description should be considered as merely illustrative of the principles, teachings and exemplary embodiments of this invention, and not in limitation thereof.

1-38. (canceled)

39. A method, comprising:
sending a mode switch command from a network access node to a first node of a pair of nodes operating in a device-to-device communication mode; and
receiving at least one acknowledgment of the reception of the mode switch command at the network access node, where the at least one acknowledgment is received from a second node of the pair of nodes.

40. The method of claim 39, where the mode switch command is an explicit mode switch command sent using layer 1 signaling to a master node of the pair of nodes.

41. The method of claim 39, where the mode switch command is an explicit mode switch command sent using a physical downlink control channel with downlink control information format 3 signaling.

42. The method of claim 39, where the acknowledgment is received on an uplink resource that is one of predefined or specified in the mode switch command.

43. The method of claim 39, where the acknowledgment of the reception of the mode switch command is interpreted by the network access node that both the first node and the second node have correctly received the mode switch command.

44. The method of claim 39, where the mode switch command is an implicit mode switch command that comprises a downlink grant to schedule the first node in the network, where the downlink grant comprises an overlay radio network identifier of the first node of the pair of nodes, and where the acknowledgment of the reception of the mode switch command is received from the second node of the pair of nodes and also from the first node of the pair of nodes.

45. The method of claim 44, where the downlink grant is sent using a physical downlink control channel, and where the first node that is scheduled sends the acknowledgment in a physical uplink control channel resource determined from a first control channel element of the physical downlink control channel, and where the second node sends the acknowledgment in a physical uplink control channel resource determined from one of a second control channel element of the physical downlink control channel or in a physical uplink control channel resource determined by the physical uplink control channel resource used by the first node, plus an offset.

46. The method of claim 44, further comprising in response to not receiving the acknowledgment from the first node and the second node, sending an explicit mode switch command using layer 1 signaling to a master node of the pair of nodes using a physical downlink control channel with downlink control information format 3 signaling.

47. The method of claim 39, further comprising sending device-to-device communication mode configuration information to the pair of nodes, while they are operating in the device-to-device communication mode, using a physical downlink control channel and a physical downlink shared channel having a cyclic redundancy code that is scrambled using a radio network identifier that is specific to the pair of nodes operating in the device-to-device communication mode.

48. The method of claim 39, further comprising sending device-to-device communication mode configuration information or downlink data to a master node of the pair of nodes, while the master node is operating in the device-to-device communication mode, using a physical downlink control channel and a physical downlink shared channel having a cyclic redundancy code that is scrambled using a radio network identifier that is assigned to the master node of the pair of nodes operating in the device-to-device communication mode, and that is different from an overlay radio network identifier of the node, and sending downlink data to a slave node of the pair of nodes, while the slave node is operating in the device-to-device communication mode, using a physical downlink control channel and a physical downlink shared channel having a cyclic redundancy code that is scrambled using a radio network identifier that is specific to the slave node of the pair of nodes operating in the device-to-device communication mode, and that is different from an overlay radio network identifier of the node.

49. An apparatus, comprising:
at least one processor; and
at least one memory including computer program code, where the memory and computer program code are configured to, with the at least one processor, cause the apparatus to send a mode switch command from a network access node to a first node of a pair of nodes operating in a device-to-device communication mode and to receive at least one acknowledgment of the reception of the mode switch command at the network access node, where the at least one acknowledgment is received from a second node of the pair of nodes.

50. The apparatus of claim 49, where the mode switch command is an explicit mode switch command sent using layer 1 signaling to a master node of the pair of nodes.

51. The apparatus of claim 49, where the mode switch command is an explicit mode switch command sent using a physical downlink control channel with downlink control information format 3 signaling.

52. The apparatus of claim 49, where the acknowledgment is received on an uplink resource that is one of predefined or specified in the mode switch command.

53. The apparatus of claim 49, where the acknowledgment of the reception of the mode switch command is interpreted by the network access node that both the first node and the second node have correctly received the mode switch command.

54. The apparatus of claim 49, where the mode switch command is an implicit mode switch command that comprises a downlink grant to schedule the first node in the network, where the downlink grant comprises a radio network identifier of the first node of the pair of nodes, and where the acknowledgment of the reception of the mode switch command is received from the second node of the pair of nodes and also from the first node of the pair of nodes.

55. The apparatus of claim 54, where the downlink grant is sent using a physical downlink control channel, and where the first node that is scheduled sends the acknowledgment in a physical uplink control channel resource determined from a first control channel element of the physical downlink control channel, and where the second node sends the acknowledgment in a physical uplink control channel resource determined from one of a second control channel element of the physical downlink control channel or in a physical uplink control channel resource determined by the physical uplink control channel resource used by the first node, plus an offset.

56. The apparatus of claim 54, where said processor is further configured to respond to not receiving the acknowledgment from the first node and the second node by sending an explicit mode switch command using layer 1 signaling to a master node of the pair of nodes using a physical downlink control channel with downlink control information format 3 signaling.

57. The apparatus of claims 49, where said processor is further configured to send device-to-device communication mode configuration information to the pair of nodes, while they are operating in the device-to-device communication mode, using a physical downlink control channel and a physical downlink shared channel having a cyclic redundancy code that is scrambled using a radio network identifier that is specific to the pair of nodes operating in the device-to-device communication mode.

58. The apparatus of claims 49, where said processor is further configured to send device-to-device communication mode configuration information or downlink data to a master node of the pair of nodes, while the master node is operating in the device-to-device communication mode, using a physical downlink control channel and a physical downlink shared channel having a cyclic redundancy code that is scrambled using a radio network identifier that is assigned to the master node of the pair of nodes operating in the device-to-device communication mode, and that is different from an overlay radio network identifier of the node, and to send downlink data to a slave node of the pair of nodes, while the slave node is operating in the device-to-device communication mode, using a physical downlink control channel and a physical downlink shared channel having a cyclic redundancy code that is scrambled using a radio network identifier that is specific to the slave node of the pair of nodes operating in the device-to-device communication mode, and that is different from an overlay radio network identifier of the node.
